(19) United States
(12) Patent Application Publication
(10) Pub. No.: US 2020/0245142 A1
(43) Pub. Date: Jul. 30, 2020

(54) MOBILE NUMBER DEVICE HISTORY USED AS A RISK INDICATOR IN MOBILE NETWORK-BASED AUTHENTICATION

(71) Applicant: ZUMIGO, INC., San Jose, CA (US)

(72) Inventors: Harish MANEPALLI, San Jose, CA (US); Chirag C. BAKSHI, San Jose, CA (US); Venkatarama PARIMI, Dublin, CA (US); Lyndi Rebecca LONG, Plant City, FL (US)

(21) Appl. No.: 16/262,811

(22) Filed: Jan. 30, 2019

(51) Int. Cl. H04W 12/06; H04W 8/18; H04L 29/08; H04W 48/14; H04W 12/08; H04L 29/06

(52) U.S. Cl. CPC H04W 12/06; H04W 8/183; H04L 67/22; H04W 84/042; H04W 12/08; H04L 63/0853; H04W 48/14

(57) ABSTRACT

The device history of a mobile telephone number, or “mobile number,” is tracked to facilitate detection of risk indicators associated with the mobile number by an application server or other authentication entity. When access to a secure account is requested from a mobile device that is activated with the mobile number, certain risk indicators can be determined based on the tracked device history of the mobile number. A history is tracked of cellular devices that have been previously activated with a particular mobile number and when each such cellular device was activated with the mobile number. When a user performs an activity with a mobile device that requires authentication based on a mobile number of the mobile device, such as an online access, risk indicators associated with the mobile number can be detected and acted on accordingly.

### BACKGROUND OF THE INVENTION

### Field of the Invention

Embodiments of the present invention generally relate to wireless tele-communication systems and, more specifically, to systems and methods for mobile number device history used as a risk indicator in mobile network-based authentication.

### Description of the Related Art

It has become common practice for possession of a mobile device to be employed as an authentication factor for login to an account or website associated with sensitive information. For example, when logging in to a bank account via an application on a mobile device or other computing device, a user may be required to confirm possession of the mobile device that is linked to the bank account. In some instances, possession is verified when the user enters a one-time password (OTP) that is sent via text message to the authorized mobile device. Alternatively, when a user attempts to access a bank account via a mobile device, access may be restricted to the mobile device that is linked to the bank account. In such instances, technologies are employed that determine the mobile number of the mobile device interacting with an application or website and report the mobile number to the bank. Thus, the bank can confirm that the bank account is being accessed by the authorized mobile device.

One drawback to using possession of a mobile device as an authentication factor is that a mobile number can be disassociated from one mobile device and associated with another mobile device. This can be problematic when the mobile number is the means by which banks and other authentication entities identify specific mobile devices. For example, mobile number is typically linked to a specific subscriber identification module (SIM), or SIM card, and not to a specific mobile device. Thus, by transferring a SIM card to a different mobile device, the mobile number linked to the SIM card can be associated with a different mobile device. Further, mobile number is not permanently linked to a single SIM card, and instead can be reassigned by a cellular network operator to another SIM card. This is commonly done when a user of a mobile device activates a previously used mobile number on a mobile device that requires a different SIM card, such as when the user changes to a different cellular network operator. In light of the above, if a fraudster can convince a cellular network operator to activate a victim's mobile number on a mobile device of the fraudster, the fraudster can employ the fraudster mobile device as an authentication factor for accessing any restricted-access account of the victim that uses the victim's mobile number as an authentication factor.

### SUMMARY OF THE INVENTION

According to one or more embodiments, the device history of a mobile telephone number, or “mobile number,” is tracked to facilitate detection of risk indicators associated with the mobile number by an application server or other authentication entity. That is, when access to a secure account that is linked to a mobile number is requested from a computing device, certain risk indicators can be determined based on the tracked device history of the mobile number. In some embodiments, a history is tracked of cellular devices that have been previously activated with a particular mobile number and when each such cellular device was activated with the mobile number. Additionally, in some embodiments, a history is tracked of subscriber identification module (SIM) cards that have been previously associated with the mobile number of interest and when each such SIM card was associated with the mobile number. Consequently, when a user performs an activity with a computing device that requires authentication based on a mobile number of a mobile device, such as an online access, risk indicators associated with the mobile number can be detected and acted on accordingly. Examples of such risk indicators include a recent change in the mobile device that is activated with the mobile number and a recent change in the SIM card associated with the mobile number. As a result, fraudulent activity associated with the mobile number can be detected, and use of the mobile number as an indicator of possession of a particular mobile device is more secure.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a mobile identity verification system, according to one or more embodiments of the present invention.

FIG. 2 is a table that displays a device history for each of a plurality of mobile numbers, according to one or more embodiments of the present invention.

FIG. 3 schematically illustrates the steps performed by the mobile identity verification system of FIG. 1 as the steps occur sequentially along a time line, according to one or more embodiments of the invention.

FIG. 4 is a flowchart of method steps for tracking a device history of a mobile number, according to one or more embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

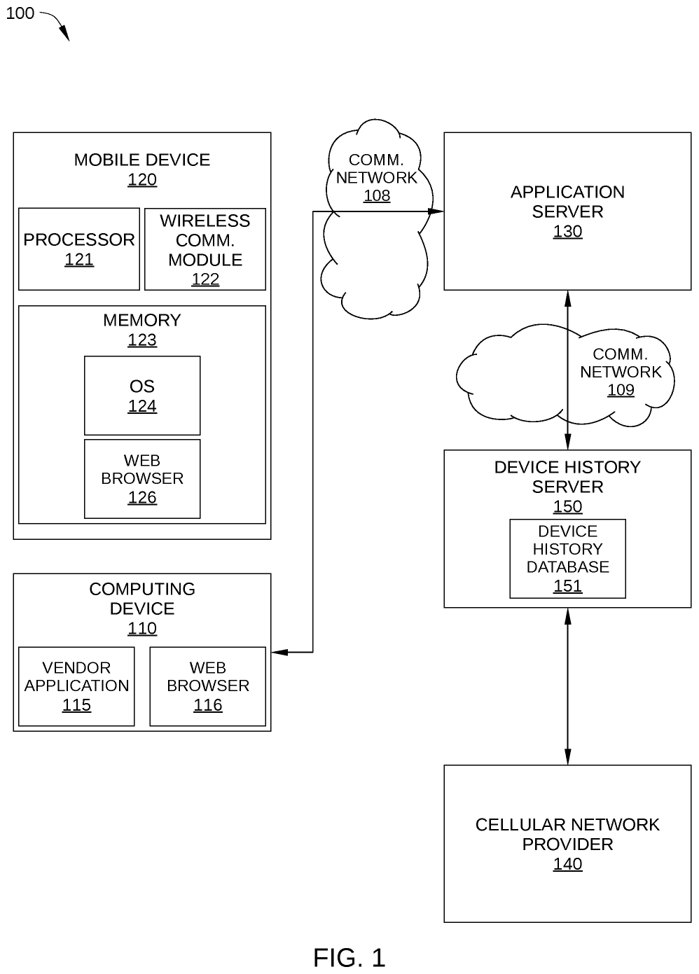

FIG. 1 is a block diagram of a mobile identity verification system 100, according to one or more embodiments of the present invention. As described below, mobile identity verification system 100 enables the device history of a mobile number to be used as a risk indicator in mobile network-based authentication. Consequently, the reliability and security of using the mobile number as an authentication factor is enhanced. More specifically, the risk indicator informs an application server or other authentication entity whether the mobile number reliably indicates possession of a particular mobile device. For example, in some embodiments, a user initiates a user activity with a computing device, such as logging in to a secure account or otherwise requesting authorized access to an application server or restricted access computing device. In such embodiments, the application server enables access to the secure account or otherwise authorizes the user activity based on 1) the mobile number of a mobile device linked to the secure account and 2) a device history of the mobile number, where the device history identifies other mobile devices, if any, that have been previously activated with the mobile number. In some embodiments, the device history may also identify other subscriber identification modules (SIMs), if any, that have been previously associated with the mobile number. Mobile identity verification system 100 includes a computing device 110, a mobile device 120 (such as a cellular telephone or smartphone), an application server 130, a cellular network provider 140, and a device history server 150. Computing device 110 is communicatively coupled to application server 130 by a communication network 108 and application server 130 is communicatively coupled to device history server 150 by a communication network 109. Communication network 108 and communication network 109 can each include a wireless local area network (WLAN), a cellular network, a wired communication network, or any combination thereof. Furthermore, while computing device 110 is shown in FIG. 1 to be communicatively coupled to application server 130 by communication network 108 and to device history server 150 by communication network 109, in other embodiments, one or more additional communication networks may also be employed to communicatively couple computing device 1110, application server 130, and device history server 150, such as the Internet, among others.

The WLAN included in communication network 108 and/or communication network 109 enables compatible devices to connect to the Internet via a wireless access point, or “hotspot.” For example, in some embodiments, the WLAN is a WiFi network that includes one or more devices based on the Institute of Electrical and Electronics Engineers (IEEE) 802.11 standard. Thus, any suitably configured wireless communication device that can connect to the WLAN, such as a smartphone with WiFi capability, can perform data transfer to and from the Internet. The cellular network included in communication network 108 and/or communication network 109 enables two-way wireless communication with wireless subscriber terminals, such as mobile device 120. For example, in some embodiments, the cellular network includes one or more base stations (not shown) that are in two-way wireless communication with wireless subscriber terminals, and with a landline system (not shown), such as the public switched telephone network (PSTN) or any other wired network capable of voice/data connections. When an active call associated with mobile device 120 is underway in the cellular network, a suitable base station translates a forward trunk signal in the landline system to a properly formatted radio signal, which is transmitted by an antenna to mobile device 120 over an air interface. Mobile device 120 performs complementary operations to enable the two-way voice or data traffic over the air interface.

Computing device 110 can be any technically feasible and network-connected computing device. For example computing device 110 can be a desktop computer, laptop computer, smartphone, personal digital assistant (PDA), tablet computer, or any other type of computing device that is configured to receive input, process data, and display images, and is suitable for practicing one or more embodiments of the present invention. Thus, computing device 110 is configured to execute a vendor application 115, a web browser 116, and/or other software applications. In addition, computing device 110 is configured to communicate with application server 130, for example via a web browser 116.

Vendor application 115 is a computer program designed to run on computing device 110. Vendor application 115 is loaded on computing device 110 and facilitates interactions with a particular website, such as application server 130, a particular database, or some other computing device. For example, in some embodiments, vendor application 115 is a banking application, a navigational program, an application that facilitates online purchasing of entertainment media from a specific website, etc.

Mobile device 120 can be a cellular telephone (also referred to as a wireless subscriber terminal), a smart phone, a personal digital assistant (PDA), a tablet computer, or any other mobile computing device configured to wirelessly access communication network 108 and communication network 109, and to practice one or more embodiments of the present invention. To that end, in some embodiments, mobile device 120 includes a processor 121, a wireless communication module 122, and a memory 123. Processor 121 may be any suitable processing unit implemented as a central processing unit (CPU), an application-specific integrated circuit (ASIC), a field programmable gate array (FPGA), any other type of processing unit, or a combination of different processing units. Wireless communication module 122 may be any suitable electronics package and or chipset configured to enable wireless communication with communication network 108 and communication network 109. Thus, in some embodiments, wireless communication module 122 includes cellular capability and WiFi capability, among others. Alternatively or additionally, in some embodiments, wireless communication module 122 includes Bluetooth capability. Memory 123 can include any suitable volatile and/or nonvolatile memory (e.g., random-access memory (RAM), read-only memory (ROM), flash memory, a magnetic hard drive, etc.), and is configured to store instructions, data, an operating system (OS) 124, and/or a web browser 126, etc.

OS 124 supports the functions of processor 121, including scheduling tasks and sending commands to vendor application 125, memory 123, and wireless communication module 122, managing the power state of mobile device 120, initiating execution of applications on processor 121, managing sockets and TCP connections, and the like. For example, in some embodiments, OS 124 is configured to facilitate the execution of web browser 126, and/or other software applications. In some embodiments, computing device 110 and mobile device 130 can be the same computing device. In such embodiments, mobile device 120 can be used to initiate a sensitive transaction with application server 130, and possession of mobile device 120 can be used as an authentication factor for the sensitive transaction.

Application server 130 can be any entity that can be accessed by mobile device 120 via WiFi network 101 and can benefit from identification and/or authorization of a user prior to access by the user. More specifically, application server 130 can be any entity that provides access to a vendor website or to sensitive information. Alternatively or additionally, application server 130 enables important data and/or financial transactions. Application server 130 can be implemented as a website, an application, a server, a database, an application running on an instance of virtual machine, and the like. Thus, in some embodiments, application server 130 is a public or open server, whereas in other embodiments, application server 130 is a restricted access only server. For example, in some embodiments, application server 130 can be a restricted access server, a merchant server, a vendor website, an e-mail server or application that enables interaction with an e-mail server, a banking website, a cloud storage server, and the like. Thus, restricted access server 130 can be any computing device, application, or other entity that can be accessed by computing device 110 via vendor application 115 or web browser 116. As noted above, vendor application 115 is configured to facilitate access to and interactions with application server 130. For example, in some embodiments, vendor application 115 enables banking transactions from a bank account associated with application server 130 an a user of computing device 110.

As noted above, in some embodiments, application server 130 stores and/or provides access to sensitive information and/or enables important data and/or financial transactions. As such, interactions with application server 130, particularly online interactions, generally require authentication, and frequently require two-factor authentication. For instance, in some embodiments, a knowledge factor (for example a user-entered personal identification number or passcode) and a possession factor (for example possession of mobile device 120) are employed by application server 130 to approve user access to application server 130 via computing device 110. That is, user access to application server 130 via computing device 110 is not approved unless a two-factor authentication process is successfully completed in which a knowledge factor and a possession factor are verified. For example, suitable knowledge factors include a user-entered personal identification number (PIN) or passcode/password. A suitable possession factor is possession of mobile device 120, where possession is indicated by electronic confirmation that the mobile number activated on the mobile device 120 performing the current interaction with application server 130 corresponds to a phone number associated with the account being accessed on application server 130.

According to various embodiments, an authorization process employs a mobile number as a possession factor and a device history of the mobile number as a risk indicator of the possession factor. The mobile number is associated with a secure account, such as a bank account or e-mail account, while the device history identifies other mobile devices and/or SIM cards, if any, that have been previously activated with the mobile number. In some embodiments, the possession factor is assumed to be satisfied when a mobile device 120 that is activated with the mobile number associated with the secure account communicates with application server 130. Further, the authorization process includes determining a risk indicator for the mobile number based on a device history of the mobile number, and, based on the risk factor, determining whether the user activity is authorized. In some embodiments, the above-described authorization process is performed by application server 130. Alternatively, in some embodiments, the above-described authorization process is performed by an external authorization entity (not shown in FIG. 1). The external authorization entity may be, for example, an application that runs on a server or other computing device that is coupled to the Internet (or to another communications network).

Cellular network provider 140 represents one or more computing devices or servers included in cellular network 102 that are employed by the provider of cellular network 102 for communicating control, status, and signaling information between nodes in cellular network 102. In some embodiments, cellular network provider 140 is included in a Signaling System 7 (SS7) network. In some embodiments, cellular network provider 140 includes the capability of cellular network 102 to allocate Internet protocol (IP) addresses to mobile devices 120 and to map currently allocated IP addresses to the mobile numbers of mobile devices 120.

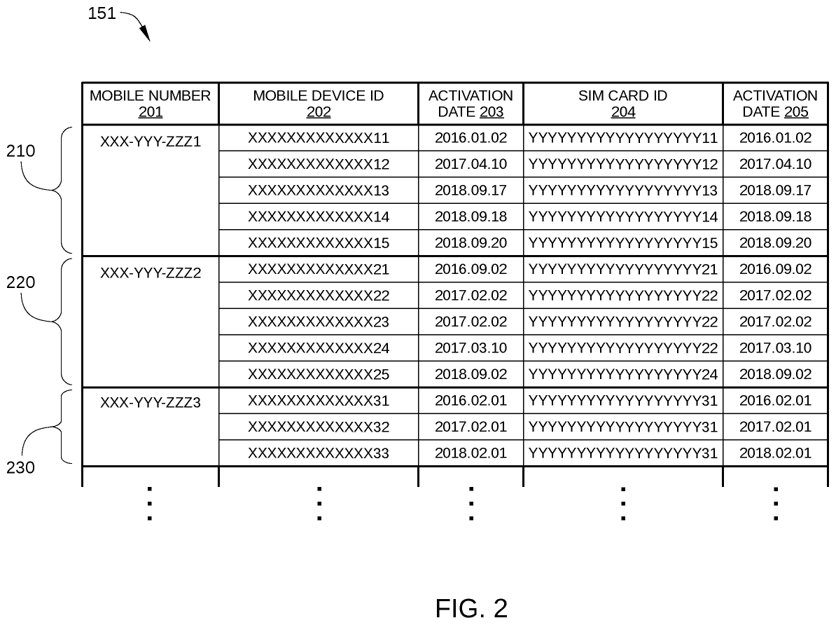

Device history server 150 may be an application that runs on a server or other computing device coupled to the Internet or other communications network, and is configured to execute device history operations as described herein. Such operations can include tracking/updating a device history for each of a plurality of mobile numbers and providing the appropriate device history to application server or to another suitable authorization entity. In this way, device history server 150 facilitates authorization of a user activity that employs the mobile number of mobile device 120 as an authentication factor by providing a device history of the mobile number to application server 130 or to the authorization entity. For example, in some embodiments, device history server 150 maintains a device history database 151 that includes a respective device history for each of a plurality of mobile numbers. One embodiment of device history database 151 is described below in conjunction with FIG. 2.

FIG. 2 shows device history database 151, according to one or more embodiments of the present invention. In FIG. 2, device history database 151 is represented as a table that includes a different device history for each of a plurality of mobile numbers 201. As shown, device history database 151 includes a device history 210 for mobile number XXX-YYY-ZZZ1, a device history 220 for mobile number XXX-YYY-ZZZ2, and a device history 230 for mobile number XXX-YYY-ZZZ3. Each device history maps the corresponding mobile number 201 to one or more mobile device identifiers (IDs) 202 and an activation date 203 for each such mobile device ID 202. By way of illustration, in FIG. 2 only three device histories 210, 220, and 230 are shown, each corresponding to a specific mobile number 201. In practice, device history database 151 can include a different device history for hundreds of thousands or more of mobile numbers 201.

Each mobile number 201 is a network ID, such as a mobile telephone number that is provided by a wireless cellular network provider 140, and is associated with a single mobile device 120. It is noted that a particular mobile number 201 can be ported to another mobile device 120, and therefore may not be permanently associated with a particular mobile device 120. Each mobile device ID 202 is a unique and non-transferable identifier associated with a particular mobile device 120, such as an international mobile equipment identifier (IMEI). Each activation date 203 indicates a date (or date/time combination) at which a corresponding mobile device ID 202 was associated with the mobile number 201. An entry is added to the device history for that particular mobile number 201 whenever a new mobile device 120 (as indicated by mobile device ID 202) is activated with the particular mobile number 201. In this way, the device history for a particular mobile number 201 is updated over time. For example, when a user ports a mobile number 201 to a new mobile device 120, a new entry is added to the device history of the ported mobile number 201, where the new entry includes the mobile device ID 202 of the new mobile device 120 and the activation date 203 indicating when the new mobile device 120 was activated with the ported mobile number 201.

In some embodiments, device histories 210, 220, and 230 further include one or more SIM card IDs 204 and an activation date 205 for each such SIM card ID 204. Each SIM card ID 204 is a unique and non-transferable identifier associated with a particular SIM card, such as an international mobile subscriber identity (IMSI), which is commonly employed by cellular network providers 140 to identify mobile devices in inter-network communications. Each activation date 205 indicates a date (or date/time combination) at which the corresponding SIM card ID 204 was associated with the mobile number 201. For example, the activation date 205 for a particular SIM card ID 204 in device history 210 can indicate a date and/or time at which the SIM card associated with that particular SIM card ID 204 was used with the mobile number 201 that corresponds to device history 210. That is, the activation date 205 can indicate when a mobile device 120 activated with the mobile number that corresponds to device history 210 is detected using a SIM card with the particular SIM card ID 204. Thus, when a user changes the SIM card in a mobile device 120, which typically occurs when changing cellular service to a different cellular network provider, device history 210 is updated with an entry that includes the SIM card ID 204 and the activation date 205. Thus, in such embodiments, each device history also maps the corresponding mobile number 201 to one or more SIM card identifiers 204 and activation dates 205 for each mobile number 201.

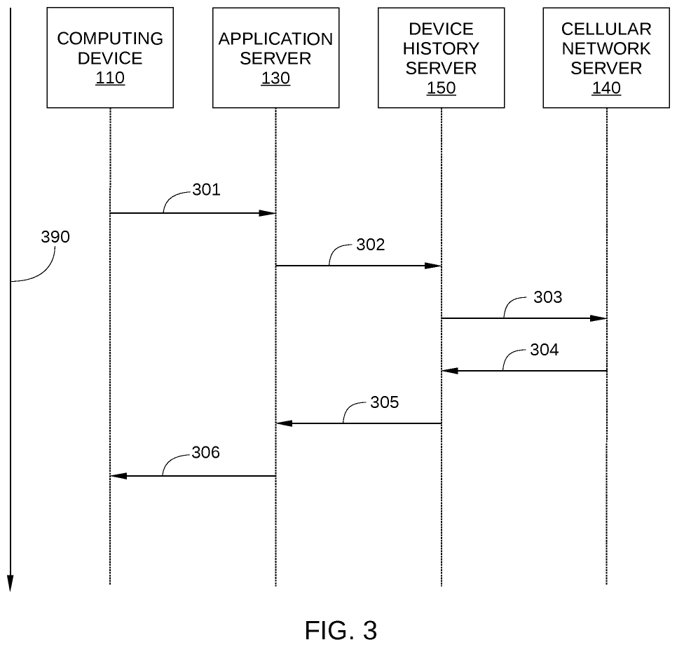

FIG. 3 schematically illustrates the steps performed by mobile identity verification system 100 as the steps occur sequentially along a time line 390, according to one or more embodiments of the invention. As noted above, when a user attempts to access application server 130 (or otherwise initiate a sensitive transaction with application server 130) via computing device 110, and possession of a mobile device 120 programmed with a network ID is an authentication factor for such an access, mobile identity verification system 100 provides to application server 130 a device history for the mobile number activated on mobile device 120. Application server 130 can then determine a risk factor associated with the mobile number based on the device history of the mobile number and whether to authorize the access based on the risk factor.

When a user attempts to initiate an online transaction or otherwise interact with application server 130, vendor application 115 or web browser 116 transmits a login request 301 to application server 130 in order to login or otherwise access application server 130. For example, after a connection is established between computing device 110 and application server 130 via communication network 108, a user may select an icon displayed by computing device 120 to initiate login request 301. The icon may be displayed by, for example, vendor application 115 or web browser 116 running on computing device 110. In some embodiments, the mobile number of mobile device 120 is included in login request 301.

Application server 130 then transmits a request for a device history 302 to device history server 150 for the mobile number activated on the mobile device 120 from which login request 301 originated. In embodiments in which login request 301 includes the mobile number activated on mobile device 120, application server 130 extracts the mobile number from login request 301 in an appropriate procedure. For example, when computing device 110 and mobile device 120 are the same device, cellular network provider 140 may include the mobile number in header information of data traffic associated with login request 301. In embodiments in which login request 301 does not explicitly include the mobile number activated on mobile device 120, application server 130 can query a cellular network provider 140 associated with communication network 108 for the mobile number based on an Internet Protocol (IP) address included in login request 301. Alternatively, in such embodiments, application server 130 can query a mobile device identification server for the mobile number based on the IP address included in login request 301. One example of such a mobile device identification server is described in detail in U.S. patent application Ser. No. 16/102,624, filed Aug. 13, 2018 and entitled “Mobile Number Verification for Mobile Network-Based Authentication,” which is incorporated herein by reference in its entirety.

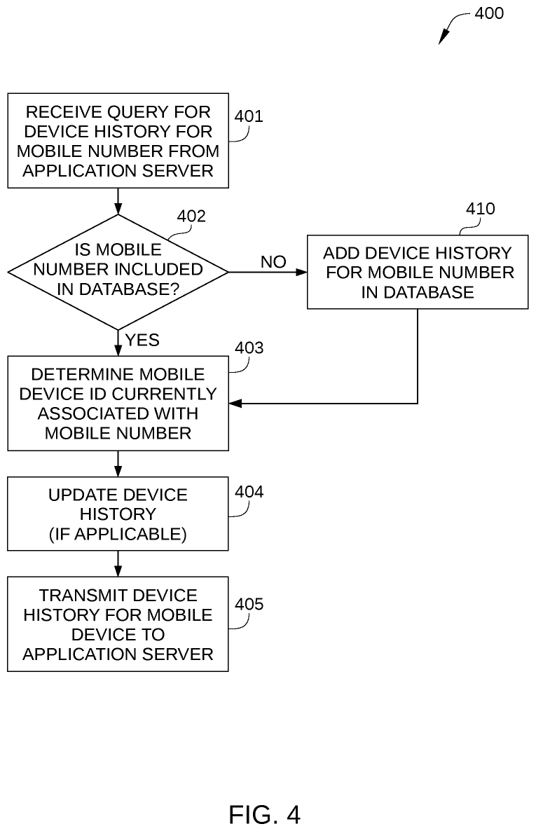

Upon receipt of request for a device history 302 from application server 130, device history server 150 determines whether a device history exists in device history database 151 for the mobile number indicated in request for device history 302. If a device history exists in device history database 151, device history server 150 transmits the appropriate device history 305 to application server 130. One embodiment of the operations of device history server 150 is described below in conjunction with FIG. 4.

FIG. 4 is a flowchart of method steps for managing device history database 151, according to one or more embodiments of the invention. Although the method steps are described in conjunction with mobile identity verification system 100 of FIG. 1, persons skilled in the art will understand that the method steps may be performed with other suitable mobile identity verification systems.

As shown, a method 400 begins at step 401, where device history server 150 receives request for device history 302 for a specified mobile number from application server 130.

In step 402, device history server 150 determines whether a device history currently exists for the specified mobile number in device history database 151. If yes, method 400 proceeds to step 403; if no, method 400 proceeds to step 410.

In step 403, device history server 150 determines a mobile device ID of the specified mobile number, i.e., the mobile device ID that is currently associated with the specified mobile number. As noted, the mobile device ID is a non-transferable identifier associated with a particular mobile device 120, such as the IMEI for that particular mobile device 120. In some embodiments, device history server 150 transmits a mobile device ID query 303 (shown in FIG. 3) to the cellular network provider 140 associated with the specified mobile number, then receives mobile device ID information 304 (shown in FIG. 3) from the cellular network provider 140 associated with the specified mobile number. Thus, mobile device ID information 304 can include a mobile device ID 202 (shown in FIG. 2). Furthermore, mobile device ID information 304 can include an activation date 203 (shown in FIG. 2) that corresponds to the mobile device ID 202.

In some embodiments, mobile device ID query 303 also includes a request for the SIM card ID for the SIM card currently associated with the mobile device 120 from which login request 301 originated. For example, in some embodiments, the SIM card ID includes the IMSI of the SIM card currently associated with the mobile device 120 that is a possession factor for authorizing login request 301. In such embodiments, the mobile device ID information 304 that device history server 150 receives from the cellular network provider 140 also includes a SIM card ID, such as a SIM card ID 204 in FIG. 2. Furthermore, in such embodiments, the mobile device ID information 304 includes an activation date 205 (shown in FIG. 2) that corresponds to the SIM card ID 204 included in mobile device ID information 304.

In step 404, in response to receiving mobile device ID information 304, device history server 150 updates the device history included in device history database 151 for the specified mobile number. More specifically, an entry is added to the appropriate device history, where the added entry includes the mobile device ID 202 and the activation date 203 included in mobile device ID information 304. In some embodiments, the entry that is added also includes the SIM card ID 204 and the activation date 205 included in mobile device ID information 304.

In step 405, device history server 150 transmits the updated device history for the mobile device 120 to application server 130 as device history information 305 (shown in FIG. 3).

In step 410, which is performed in response to determining that no device history currently exists for the specified mobile number in device history database 151, device history server 150 adds a device history for the specified mobile number in device history database 151.

Returning to FIG. 3, device history server 150 transmits device history information 305 to application server 130 in response to request for a device history 302. The device history information 305 transmitted to application server 130 by device history server 150 includes the mobile device ID(s) 202 and corresponding activation date(s) 203 associated with the mobile number 201 of interest. In some embodiments, the device history information 305 transmitted to application server 130 further includes the SIM card ID(s) 204 and corresponding activation date(s) 205 associated with the mobile number 201 of interest. The device history information 305 transmitted to application server 130 by device history server 150 can be in a plain text, encrypted, or any other suitable format. Application server 130 then determines a risk indicator for the specified mobile number 201 based on device history information 305 received from device history server 150. In some embodiments, examples of such risk factors include a recent change from one mobile device ID 202 to another mobile device ID 202 that is associated with the mobile number 201; a recent change from one SIM card ID 204 to another SIM card ID 204 that is associated with the mobile number 201; a high frequency of changes in mobile device ID 202 and/or SIM card ID 204 associated with the mobile number 201, and the like.

Based on the risk factor that are detected, or on the lack of detected risk factors, application server 130 determines whether the user activity associated with login request 301 is authorized. In response to determining that the user activity is authorized, application server 130 transmits an authorization notification 306 to the computing device 110 from which login request 301 originated, and the user of that computing device 110 can interact with application server 130 normally. Any suitable risk assessment algorithm may be employed in by application server 130 to determine whether interactions with application server 130 are allowed. In some embodiments, a risk assessment algorithm employed by application server 130 is based on one or more of the above-described risk factors.

By performing the steps in FIG. 3, mobile identity verification system 100 enhances the security of using a mobile number as a possession factor for a particular mobile device 120, since suspicious activity associated with that mobile number can be detected prior to authorizing a user activity with that mobile number.

In the embodiments described above, device history server 150 maintains and updates device history database 151. Alternatively, in some embodiments, some or all of the information included in device history database 151 of FIG. 2 can be maintained and updated by application server 130. In such embodiments, application server 130 performs some or all of the operations set forth in the flow chart of FIG. 4.

In sum, embodiments described herein enable a mobile number of a mobile device to be securely employed as a possession factor. Specifically, when a user attempts to interact with a restricted access server or restricted access account via a computing device, certain risk indicators for the mobile number can be determined based on the device history of the mobile number with which the mobile device is currently programmed. Authentication of the user activity can then be based the risk indicators so determined for the mobile number.

While the foregoing is directed to embodiments of the present invention, other and further embodiments of the invention may be devised without departing from the basic scope thereof, and the scope thereof is determined by the claims that follow.

We claim:

1. A computer-implemented method of authorizing a user activity based on a first mobile device on which a mobile number has been activated, the method comprising:
receiving a request from a computing device for authorized access to an application server;
determining a risk indicator for the mobile number based on a device history of the mobile number that includes an identifier for at least one mobile device that has been activated with the mobile number; and
upon determining that the risk indicator is below a threshold, allowing the computing device to access the application server.

2. The computer-implemented method of claim 1, wherein the application server comprises a restricted access computing device.

3. The computer-implemented method of claim 2, further comprising, based on the risk factor, enabling access via the computing device to a secure account associated with the restricted access computing device.

4. The computer-implemented method of claim 1, further comprising:
in response to receiving the request from the computing device, querying a mobile device identification server for the device history; and
receiving the device history from the mobile device identification server.

5. The computer-implemented method of claim 1, further comprising, in response to receiving the request from the computing device, determining the mobile number based on information included in the request from the computing device.

6. The computer-implemented method of claim 1, wherein the device history further includes a time at which the at least one mobile device was associated with the mobile number.

7. The computer-implemented method of claim 1, wherein the device history further includes an identifier for at least one subscriber identification module (SIM) that has been associated with the mobile number.

8. The computer-implemented method of claim 7, wherein the device history further includes a time at which the at least one subscriber module was associated with the mobile number.

9. The computer-implemented method of claim 1, wherein the first mobile device is being used to login to a secure account associated with the application server.

10. The computer-implemented method of claim 1, wherein the identifier for the at least one mobile device comprises an international mobile equipment identifier.

11. The computer-implemented method of claim 1, further comprising, upon determining that the risk indicator is above the threshold, preventing the computing device from accessing the application server.

12. A restricted-access system of computing devices, comprising:
a first mobile device on which a mobile number has been activated; and
an application server, configured to:
receive a request from a computing device for authorized access to the application server;
determine a risk indicator for the mobile number based on a device history of the mobile number that includes an identifier for at least one mobile device that has been activated with the mobile number; and
upon determining that the risk indicator is below a threshold, allow the computing device to access the application server.

13. The restricted-access system of computing devices of claim 12, further comprising a mobile device identification server communicatively coupled to the application server and, and wherein the application server is configured to determine the risk factor for the mobile number by:
querying the mobile device identification server for the device history; and
receiving the device history from the mobile device identification server.

14. The restricted-access system of computing devices of claim 13, wherein the mobile device identification server is configured to:
in response to the query, determine an identifier for the first mobile device; and
update an entry in the device history with the identifier for the first mobile device.

15. The restricted-access system of computing devices of claim 13, wherein the mobile device identification server is configured to determine the identifier for the first mobile device by:
querying a cellular network provider associated with the mobile number; and
receiving the identifier for the first mobile device from the cellular network provider.

16. The restricted-access system of computing devices of claim 12, wherein the device history further includes a time at which the at least one mobile device was associated with the mobile number.

17. The restricted-access system of computing devices of claim 1, wherein the device history further includes an identifier for at least one subscriber identification module (SIM) that has been associated with the mobile number.

18. The restricted-access system of computing devices of claim 12, wherein the device history further includes a time at which the at least one subscriber module was associated with the mobile number.

19. The restricted-access system of computing devices of claim 12, wherein the computing device is being used to login to a secure account associated with the application server.

20. The restricted-access system of computing devices of claim 12, wherein the application server is further configured to, upon determining that the risk indicator is above the threshold, preventing the computing device from accessing the application server.
